(19) United States
(12) Patent Application Publication
(10) Pub. No.: US 2008/0007855 A1
(43) Pub. Date: Jan. 10, 2008

(54) Phase offset correction for timing recovery with use of ECC in a read channel for a disk drive

(75) Inventors: Andrei E. Vityaev, San Jose, CA (US); Thomas V. Souvignier, Longmont, CO (US); Gregory L. Silvus, Boulder, CO (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/643,172

(22) Filed: Dec. 21, 2006

Related U.S. Application Data
(60) Provisional application No. 60/819,588, filed on Jul. 10, 2006.

(51) Int. Cl. G11B 5/09

(52) U.S. Cl. 360/51

(57) ABSTRACT

A technique to sample a signal from a disk by using frequency and phase offset adjustment in a phase locked loop (PLL) timing recovery loop to sample read data from the disk, prior to a disk clocked clocking acquires a lock. Subsequently, sampling a signal from a disk by using only phase offset adjustment in the PLL timing recovery loop to sample read data from the disk after the disk clocked clocking acquires the lock. The sampled data is then error corrected by applying an error correction code (ECC).

### CROSS REFERENCE TO RELATED APPLICATION

This application claims the benefit of priority to U.S. Provisional Patent Application Ser. No. 60/819,588; filed Jul. 10, 2006; and titled “Phase offset correction for timing recovery with use of ECC in a read channel for a disk drive,” which is incorporated herein by reference.

### BACKGROUND OF THE INVENTION

1. Technical Field of the Invention

The embodiments of the invention relate generally to disk drives and, more particularly, to a use of ECC in combination with a timing recovery scheme in a disk drive.

2. Description of Related Art

Varieties of memory storage devices, such as magnetic disk drives, are available to store data and are used to provide data storage for a host device, either directly, or through a network. Those networks may be a storage area network (SAN) or a network attached storage (NAS). Typical host devices include stand alone computer systems such as a desktop or laptop computer, enterprise storage devices such as servers, storage arrays such as a redundant array of independent disk (RAID) arrays, storage routers, storage switches and storage directors, and other consumer devices such as video game systems and digital video recorders. These devices generally provide high storage capacity in a cost effective manner. Disk drives, including hard disk drives (HDDs), comprise one category of such storage devices.

With some of the HDDs, there may be performance issues associated when performing timing recovery of a signal that is read from the disk. That is, appropriate digital sampling is performed for accurate and effective recovery of the information from signals read from the disk. If improper or inadequate digital sampling is performed on the signal that is read from the disk, then some of the data recovered may be inaccurate or not recovered at all. In order to obtain improved performance for data sampling in a HDD, some HDD systems employ the use of a timing recovery loop in its read channel. The timing recovery loop generally provides feedback in the read channel of the disk drive to improve the sampling of the data read from the disk.

Another HDD practice is to bring the HDD up to a desired rotational speed utilizing a motor controller that controls the rotational speed of the disk. Since, in some instances, the adjusting of the HDD motor may not provide the degree of accuracy needed for reading the data from the disk, some HDD devices use a disk-locked clocking scheme. A disk-locked clocking system adjusts the electrical circuitry (such as the disk clocking circuitry) to synchronize with the motor speed, instead of just controlling the speed of the motor. That is, instead of just accurately controlling the motor speed, the fine adjustment to maintain the timing is performed by adjusting the electronics to the disk rotation.

Even with the use of disk-locked clocking control circuitry, present 512 byte sector size HDD devices require a bit error rate (BER) of approximately 10⁻⁴ (1 bit error per 10,000 bits). Since BER (bit errors/total bits) and signal-to-noise ratio (SNR) are related to HDD performance, a degradation of SNR (which is signal power/noise power) generally results in a worse BER for the HDD. When HDDs migrate to larger sector sizes, such as to 4096 (4K) byte sector size, currently used sampling techniques may not be able to retain the desired SNR, and hence the desired BER, because of the larger amount of data being read per sector. Therefore, a new generation of HDDs may need to employ tighter data read controls in order to maintain acceptable BER with lower SNR when reading data from a larger sector size HDD. Existing techniques alone may not be adequate to provide the acceptable BER at the new larger sector sizes.

Accordingly, there is a need for a HDD that employs techniques to obtain acceptable BER for larger sector sizes disks.

### SUMMARY OF THE INVENTION

The present invention is directed to apparatus and methods of operation that are further described in the following Brief Description of the Drawings, the Detailed Description of the Embodiments of the Invention, and the Claims. Other features and advantages of the present invention will become apparent from the following detailed description of the embodiments of the invention made with reference to the accompanying drawings.

### BRIEF DESCRIPTION OF THE SEVERAL VIEWS OF THE DRAWINGS

FIG. 1 shows an embodiment of a disk drive device for practicing the invention.

FIG. 2 shows one embodiment of an apparatus that includes a disk controller.

FIG. 3 shows another embodiment of an apparatus that includes a disk controller.

FIG. 4 shows a block diagram of an embodiment of a data sampler using a PLL phase recovery and ECC.

FIG. 5 shows a block diagram of another embodiment of a data sampler using a PLL phase recovery and ECC.

FIG. 6 shows a method of practicing an embodiment of the invention in which data sampling using a PLL phase recovery is used in conjunction with ECC.

### DETAILED DESCRIPTION OF THE EMBODIMENTS OF THE INVENTION

The embodiments of the present invention may be practiced in a variety of settings that implement a hard disk drive (HDD) or other memory storage devices that utilize a motor, or some such moving device, to rotate a storage medium. The HDD may be stand alone, implemented within another device or integrated in a device or product.

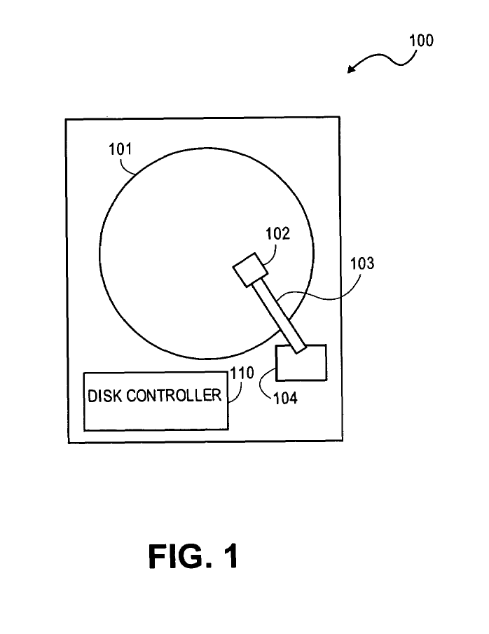

FIG. 1 illustrates an example embodiment of a disk drive 100 for practicing one embodiment of the invention. In particular, disk drive 100 is a HDD device that includes a disk 101 to store data. Disk 101 is typically rotated by a servo or motor (not shown) at a specified velocity depending on a particular application for its use. Disk 101 may be constructed from various materials and in one embodiment, disk 101 is a magnetic disk that stores information as magnetic field changes on some type of magnetic medium. The medium may be rigid or non-rigid, although HDD devices generally have rigid disks. Disk 101 may be removable or non-removable. Disk 101 typically is made of magnetic material or coated with magnetic material. It is to be noted that in other embodiments, disk 101 may employ other data storage technology, such as an optical medium, and need not be limited to magnetic storage.

Disk drive 100 typically includes one or more read/write heads 102 that are coupled to an arm 103 that is moved by an actuator 104 over the surface of the disk 101 either by translation, rotation or both. Disk drive 100 may have one disk 101, or multiple disks with multiple read/write heads 102. Disk drive 100 includes a disk controller module 110 that is utilized for controlling the operation of the disk drive, including read and write operations to disk 101, as well as controlling the speed of the servo motor and the motion of actuator 108. Disk controller module 110 may also include an interface to couple to an external device, such as a host device. It is to be noted that disk drive 100 is but one example and other disk drives may be readily implemented to practice various embodiments of the invention.

Disk drive 100, or any other equivalent disk drive, may be implemented in a variety of devices. For example, disk drive 100 may be implemented in a handheld audio unit. In one such embodiment, disk drive 100 may include a small form factor magnetic hard disk that has a diameter of approximately 1.8″ or smaller and incorporated into or otherwise used by handheld audio unit to provide general storage, including storage of audio content.

In another example embodiment, disk drive 100 may be implemented in a computer. In one such embodiment, disk drive 100 may include a small form factor magnetic disk that may be used in a variety of applications, including enterprise storage applications. Disk drive 100 is incorporated into or otherwise used by a computer to provide general purpose storage and the computer may be attached to a storage array, such as a redundant array of independent disks (RAID) array, storage router, edge router, storage switch and/or storage director. Disk drive 100 may be implemented in a variety of computers (or computing devices), such as desktop computers and notebook computers.

In another example embodiment, disk drive unit 100 may be implemented in a wireless communication device to provide general storage. In one such embodiment, the wireless communication device may communicate via a wireless telephone network such as a cellular, personal communications service (PCS), general packet radio service (GPRS), global system for mobile communications (GSM), integrated digital enhanced network (iDEN) or other wireless communications network capable of sending and receiving telephone calls. Furthermore, the wireless communication device may communicate via the Internet to access email, download content, access websites, and provide streaming audio and/or video programming. In this fashion, the wireless communication device may place and receive telephone calls, text messages, short message service (SMS) messages, pages and other data messages that may include attachments such as documents, audio files, video files, images and other graphics.

Still as another example, disk drive 100 may be implemented in the personal digital assistant (PDA). In one such embodiment, disk drive 100 may include a small form factor magnetic hard disk to provide general data storage.

In these various embodiments for disk drive 100, a variety of data, as well as program instructions, may be stored. Stored data may include, and is not limited to, general data, data for motion picture expert group (MPEG) audio layer 3 (MP3) files or Windows Media Architecture (WMA) files, video content such as MPEG4 files, JPEG (Joint Photographic Expert Group) files, bitmap files and files stored in other graphics formats, emails, webpage information and other information downloaded from the Internet, address book information, and/or any other type of information that may be stored on a disk medium.

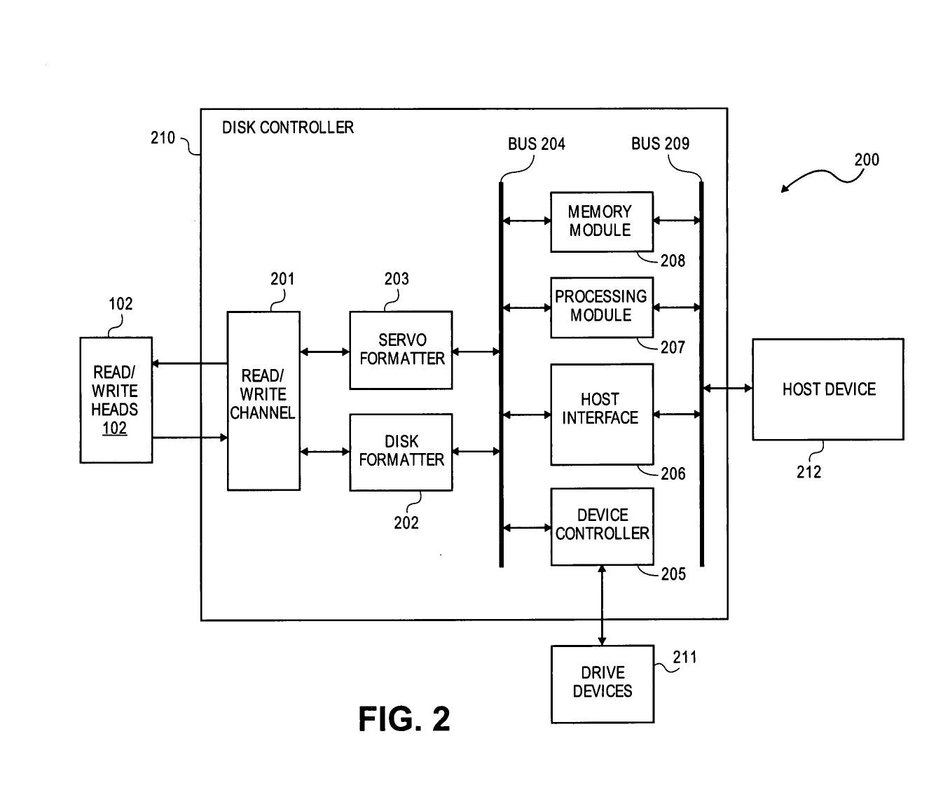

FIG. 2 illustrates an embodiment of an apparatus 200 that may be implemented with disk drive 100 of FIG. 1. Read/write head 102 is shown coupled to a disk controller 210, which may be used for disk controller 110 of FIG. 1. In the particular embodiment, disk controller 210 includes a read/write channel 201 coupled to head 102 for reading and writing data to and from disk 101. A disk formatter 202 is included for controlling the formatting of data and provides clock signals and other timing signals that control the flow of the data written to, and data read from disk 101 through read/write channel 201. A servo formatter 203, also coupled to read/write channel 201, provides clock signals and other control and timing signals based on servo control data read from disk 101. Disk formatter 202 and servo formatter 203 are also coupled to bus 204. Disk controller 210 further includes a device controller 205, host interface 206, processing module 207 and memory module 208, as well as a second bus 209. Device controller 205 controls the operation of a drive device(s) 211. Device(s) 211 may be devices such as actuator 108 and the servo (or spindle) motor used to rotate disk 101. Host interface 206 is coupled to a host device 212 to receive commands from host device 212 and/or transfer data between host 212 and disk 101 in accordance with a particular protocol.

Processing module 207 may be implemented using one or more microprocessors, micro-controllers, digital signal processors, microcomputers, central processing units, field programmable gate arrays, programmable logic devices, state machines, logic circuits, analog circuits, digital circuits, and/or any devices that manipulates signal (analog and/or digital) based on operational instructions. The operational instructions may reside in memory module 208 or may reside elsewhere. When processing module 207 is implemented with two or more devices, each device may perform the same steps, processes or functions in order to provide fault tolerance or redundancy. Alternatively, the function, steps and processes performed by processing module 207 may be split between different devices to provide greater computational speed and/or efficiency.

Memory module 208 may be a single memory device or a plurality of memory devices. Such a memory device may be a read-only memory (ROM), random access memory (RAM), volatile memory, non-volatile memory, static random access memory (SRAM), dynamic random access memory (DRAM), flash memory, cache memory, and/or any device that stores digital information. It is to be noted that when processing module 207 implements one or more of its functions via a state machine, analog circuitry, digital circuitry, and/or logic circuitry, memory module 208 storing the corresponding operational instructions may be embedded within, or reside external to, the circuitry comprising the state machine, analog circuitry, digital circuitry, and/or logic circuitry. Furthermore, memory module 208 stores, and the processing module 207 executes, operational instructions that may correspond to one or more of the steps or a process, method and/or function illustrated herein.

Each of these elements of controller 210 may be implemented in hardware, firmware, software or a combination thereof, in accordance with the broad scope of the present invention. While a particular bus architecture is shown in FIG. 2 with buses 204, 209, alternative bus architectures that include either a single bus configuration or additional buses are likewise possible to be implemented as different embodiments.

In one embodiment, one or more modules of disk controller 210 are implemented as part of a system on a chip (SoC) integrated circuit. In the particular embodiment shown, disk controller 210 is part of a SoC integrated circuit that may include other circuits, devices, modules, units, etc., which provide various functions such as protocol conversion, code encoding and decoding, power supply, etc. In other embodiments, the various functions and features of disk controller 210 may be implemented in a plurality of integrated circuits that communicate and combine to perform the functionality of disk controller 210.

When the drive unit 100 is manufactured, disk formatter 203 generally writes a plurality of servo wedges along with a corresponding plurality of servo address marks at equal radial distance along the disk 101. The servo address marks are used by the timing generator for triggering a “start time” for various events employed when accessing the media of the disk 101.

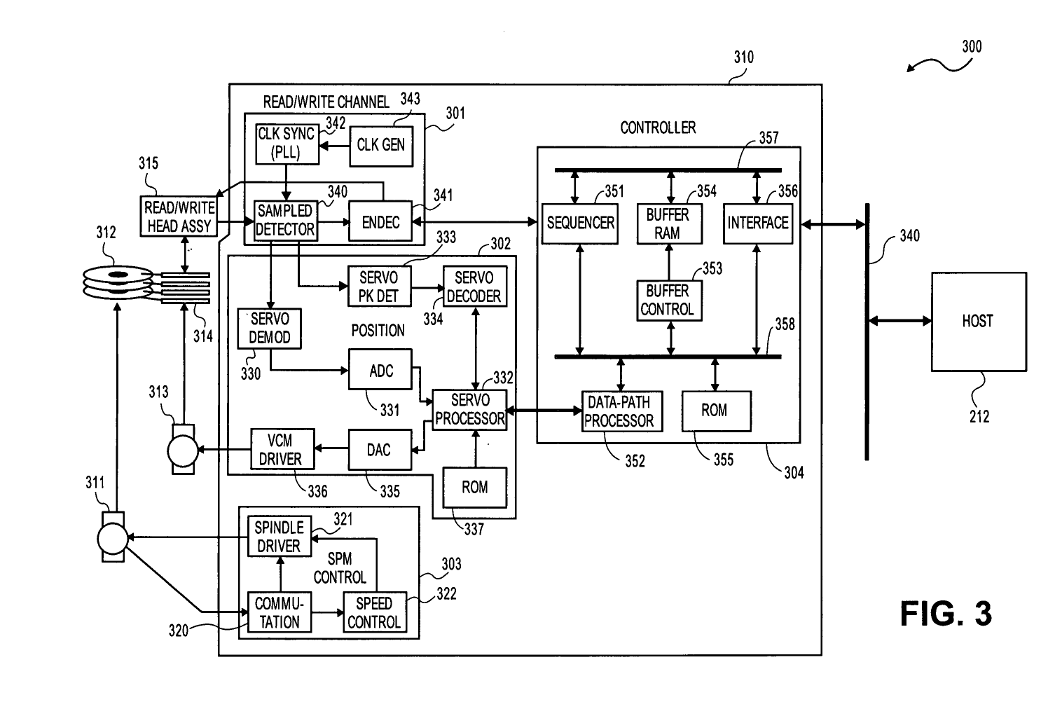

FIG. 3 illustrates another embodiment of an apparatus 300 that may be implemented with disk drive 100 of FIG. 1. Apparatus 300 includes a disk controller 310, which may be used for disk controller 110 of FIG. 1. In this particular embodiment, disk controller 310 includes a read/write channel module 301, position module 302, spindle motor (SPM) control module 303 and controller module 304. As shown, disk controller 310 is integrated on an integrated circuit chip and in some embodiments, disk controller 310 may also be implemented as a SoC. Alternatively, as noted above, disk controller 310 may be implemented in multiple chips, or even as discreet components.

Apparatus 300 of FIG. 3 is shown having a spindle servo or motor 311, which turns one or more disks 312. In the illustration, multiple disks 312 are shown. However, the disk drive may only have one disk in other embodiments. Hereinafter, the description refers to disks 312, but it is understood that there may only be one disk present. The disks 312 may be rigid or non-rigid, but in typical HDD units, the disks 312 are rigid media for storing data.

Apparatus 300 also includes an actuator servo (or motor) 313 to move read/write head or heads 314. Read/write heads 314 are part of a read/write head assembly 315 which read data from disks 312, as well as write data to disks 312. In some embodiments, head assembly 315 may include a preamplifier to provide preamplification of data read from disks 312.

In the embodiment of FIG. 3, SPM control module 303 includes a commutation module 320 to monitor the speed of spindle motor 311, a spindle driver 321 to drive the spindle motor 311, and a speed control module 322 to control the spindle driver based on the input provided by commutation module 320. SPM control module 303 is used to measure the disk speed and provides feedback to coarsely control the disk speed.

Likewise, position module 302 is used to control head actuator servo 313 to precisely place the heads 314 over a desired location on disks 312 to read or write data. The position module 302 includes a servo demodulator 330 to demodulate signals from read/write channel module 301 and the demodulated output from servo demodulator 330 is coupled to an analog-to-digital converter (ADC) 331. Demodulator 330 looks at the signal coming from the head and determines how far off the head is from being on the right track. ADC 331 converts the analog demodulated signal to a digital form for input to a servo processor 332. A second signal path from read/write channel module 301 is coupled to a servo peak detector 333, which identifies the 0's and 1's of the servo information, to determine where the head is over the disk. The output from peak detector 333 is then decoded by servo decoder 334 for input to processor 332. The demodulated and decoded information is processed by processor 332 and utilized to generate drive signals for voice coil motor (VCM) driver 336. A digital-to-analog converter (DAC) 335 is used to convert digital control signals from processor 332 into analog form. VCM driver 336 then uses the feedback loop to operate actuator servo 313 to correct the positioning of the head(s). A memory 337, shown as a ROM, is included to store instructions to operate processor 332.

Read/write channel module 301 includes a sampled detector 340 for sampling and detecting a read signal from assembly 315. The analog read data from the disk is coupled to detector 340, via head assembly 315, to be sampled and detected. The detected signal is coupled to encoder/decoder (ENDEC) module 341 to be decoded. Typically, detector 340 has an ADC to provide analog-to-digital conversion. ENDEC module 341 then decodes digital form of the sampled/detected read data and couples the read data to controller module 304. Outputs from detector 340 are also coupled to demodulator 330 and detector 333. During a write operation, ENDEC module 341 receives digital data from controller module 304 and encodes the data for writing to the disk through head assembly 315.

Read/write channel module 301 includes a clock generator 343 to provide a reference clock for generating other timing and/or clock signals for use by one or more components of disk controller 310. In other embodiments, the reference clock may be provided from a clock source external to disk controller 310, or even apparatus 300. A clock synchronizer module 342 receives the reference clock and generates clocking or timing signals for coupling to detector 340. In one embodiment, synchronizer 342 uses a phase-locked-loop (PLL) to synchronize the sampling timing of detector 340 when sampling data from disks 312.

ENDEC 341 is coupled to sequencer 351 of controller module 304 for transfer of data between read/write module 301 and controller module 304. Controller module 304 includes sequencer 351, data-path processor 352 and its memory (in way of a ROM) 355, buffer memory (shown as a RAM) 354, buffer control circuitry 353 and interface 356. As noted above, sequencer 351 provides for the transfer of data between modules 301, 304. Buffer 354, under control of buffer control circuitry 353, stores data that is to be written to the disk or was read from the disk. Interface 356 is used to interface disk controller 310 with host 212 via bus 340. As shown, bus 357 is used as an internal bus for data transfer among sequencer 351, buffer 345 and interface 356.

As noted in FIG. 3, a second bus 358 is used to couple control and data signals between various devices on controller module 304. Data-path processor 352 is coupled to bus 358 for transfer of control and/or data signals. ROM 355, also coupled to bus 358, is utilized to store instructions which operate on processor 352. It is to be noted that specific circuit nomenclature, such as RAM and ROM, are provided as examples only and various other memory devices (both internal or external to disk controller 310) may be utilized. Again, as noted above, although specific components are shown, they need not be limited to such components. Thus, shown processors may be microprocessors, processing modules, state machines, microcode, etc.

As earlier described in the Background section above, the use of appropriate sampling techniques allows effective recovery of stored information read from the disk. Higher performing HDD devices may implement disk-locked clocking techniques to fine-align the electronics to compensate for looser tolerance of mechanical devices, such as disk drives. However, degradation of SNR may result in degraded BER, even with the use of disk-locked clocking control circuitry. Present use of 512 byte sector size HDD devices generally require a BER of approximately 104 (1 bit error per 10,000 bits), but when HDDs migrate to a larger sector size, such as 4096 (4K) byte sector size, it may be difficult to maintain an acceptable BER.

One way to ensure an acceptable BER is to maintain an adequate SNR. However, if a desired SNR is not possible or reasonably obtainable, then some other technique may need to be employed, which allows a lower SNR, but that which also provides for an acceptable BER.

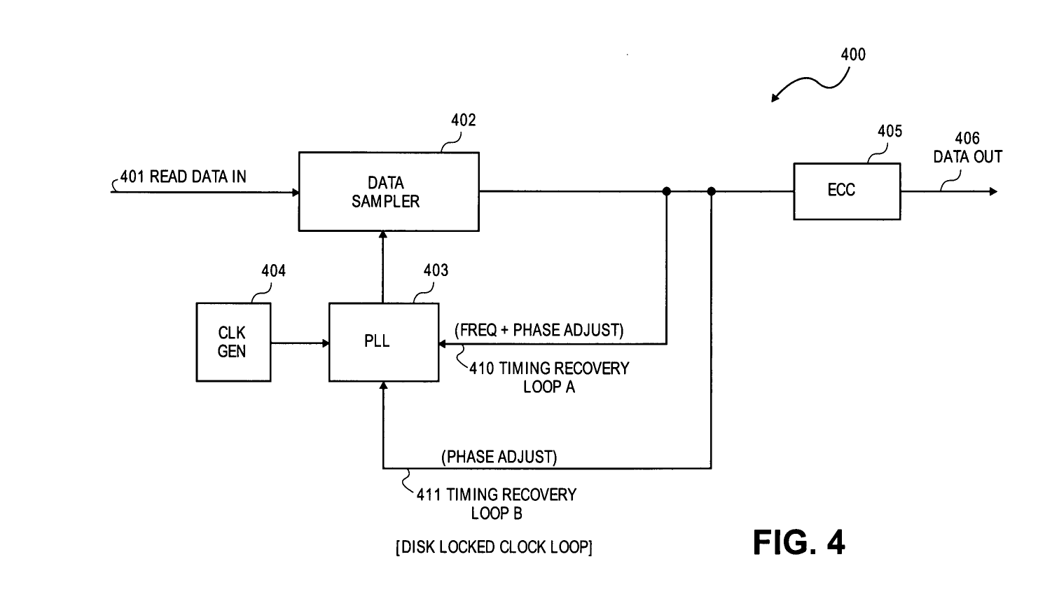

FIG. 4 shows one embodiment of the invention to address tolerances of HDDs, but still allow an acceptable BER for data being recovered from the disk. FIG. 4 shows an apparatus 400 that is used to sample data read from a disk and to maintain an acceptable BER for correct recovery of data. Apparatus 400 includes a data sampler 402, a phase-locked-loop (PLL) 403 and an error correction code (ECC) module 405. A reference clock generator 404 is shown generating a reference clock signal to PLL 403, but in some embodiments the reference clock may be generated elsewhere and sent to PLL 403.

Data sampler 402 receives read data input 401 from the read head(s), such as read/write heads 102 of FIG. 1 or read/write head assembly 315 of FIG. 2. Read data input is an analog signal from the disk, so that sampling is provided by data sampler 402. Data sampler 402 may use a variety of techniques to sample the read data signal. The reference clock signal from clock generator 404 is coupled to PLL 403 to provide a reference timing signal to data sampler 402 to sample the incoming data. A feedback loop from the output of data sampler 402 is then fed back to PLL 403 to provide offset correction to adjust the sampling time in reference to the PLL output to the data sampler 402. Typically, an ADC is present in data sampler 402, so that the output of data sampler 402 is a digital signal. The output of data sampler 402 is coupled to an error correction code module 405, as well as providing a feedback signal back to PLL 403. It is to be noted that in some embodiments, the feedback signal may be taken at the output of ECC 405

It is to be noted that a function of a PLL is to have a timing recovery loop to compare received samples to what the samples should be, based on an earlier decoded data. An offset component is then used to make a correction. In typical operation, phase or frequency correction is made to obtain timing synchronization. Accordingly, PLL 403 performs equivalently in comparing a parameter of received read data samples to earlier samples via the feedback loop. However, with PLL 403, there are two recovery timing feedback loops to choose from, depending on the state of a disk-locked clocking (DLC) scheme/system.

As noted in FIG. 4, there are two timing recovery loops to PLL 403 from the output of data sampler 402. Timing recovery loop 410 (also noted as Loop A) is utilized to correct for both frequency and phase offset in synchronizing the data sampler 402. Timing recovery loop 411 (also noted as Loop B) is utilized to correct for phase offset only. Timing recovery loop B is also noted as disk-locked clock (DLC) loop, since its operation is based on the DLC being in a locked (DLC acquired) condition. In operation, when disk rotation commences, PLL 403 uses the reference clock from the clock generator 404 to set the sampling time of the input data 401. At this time a DLC scheme/system is commencing to acquire the lock, but has not yet done so. While the DLC is still looking to lock, PLL 403 uses Loop A for timing recovery. That is, PLL 403 recovery timing is corrected by performing frequency and phase offset adjustment to synchronize the read data input sampling to the reference clock signal.

Subsequently, once the DLC loop acquires a lock, so that circuit electronics are made adjustable to compensate for disk rotation tolerances, PLL 403 uses Loop B for recovery timing, in which only the phase adjustment is used in the PLL feedback loop. Once DLC locks on, the recovery timing is corrected by phase offset adjustment only.

The sampled data output is provided to error correction code (ECC) module 405 to perform error correction. A variety of ECC schemes may be used with ECC module 405. One such ECC scheme employs Reed-Solomon ECC. Accordingly, in one embodiment, ECC module 405 uses Reed-Solomon ECC to perform error correction on the sampled data to generate an ECC corrected data output 406. Other embodiments may use other ECC schemes.

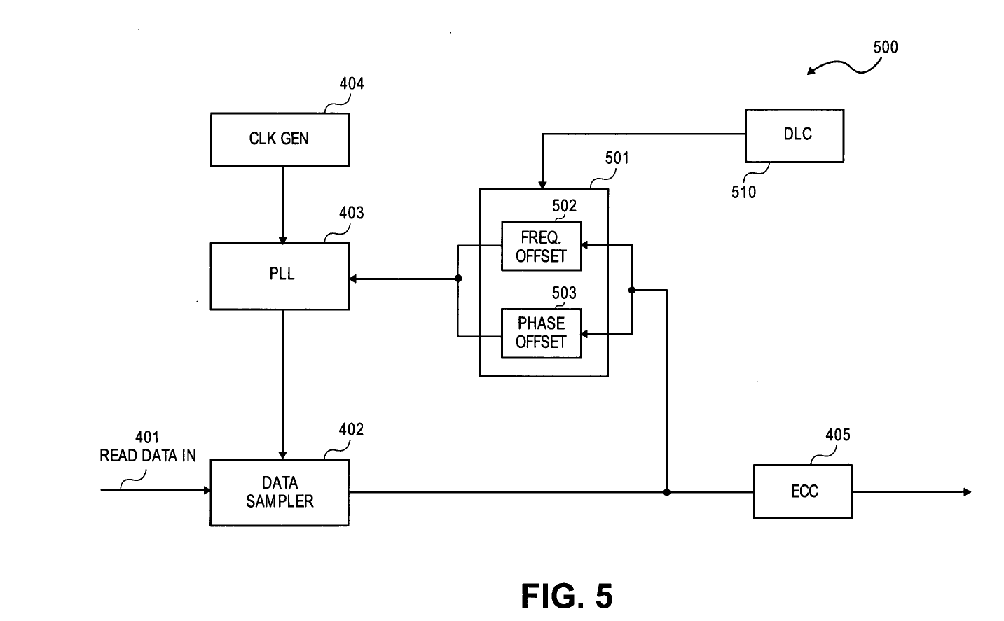

FIG. 5 shows an alternative embodiment of the invention in which timing recovery loop 410 and loop 411 are obtained through a single feedback loop via timing recovery module 501 in apparatus 500. Timing recovery module 501 includes a frequency offset module 502 and phase offset module 503. Timing recovery module 501 is also coupled to a DLC module 510, which sends an indication to timing recovery module 501 indicating when DLC lock occurs. Initially, when timing recovery is initiated, both frequency offset and phase offset modules 502, 503 are enabled to make timing recovery correction, while DLC is attempting to acquire the lock. However, when DLC lock does occur, DLC module 510 sends an indication to module 501 in order to disable (or remove from operation) frequency offset module 502, so that only phase offset module 503 is active to make the timing recovery.

A variety of techniques, including known techniques, may be employed to provide frequency and/or phase offset in a PLL to correct or recover proper timing for sampling data. The PLL timing recovery may be achieved by hardware, software, firmware, or combinations of these methods. Similarly a variety of DLC techniques, including known techniques, may be employed for DLC control of mechanical devices, such as disk servos/motors.

Furthermore, a co-pending patent application titled “Timing Recovery Optimization Using Disk Clock,” having an application Ser. No.; ______ filed ______; which is incorporated herein by reference, also describes a technique of using a PLL with a timing recovery loop and a disk-locked clock loop. The described technique of the co-pending application may be used in some embodiments to provide the two timing recovery loops A and B noted above.

The apparatus 400 of FIG. 4 or apparatus 500 of FIG. 5 may be implemented in a variety of HDD devices. When implemented in the disk controller 210 of FIG. 2, apparatus 400 or apparatus 500 may be implemented in the read channel 201. When implemented in the disk controller of FIG. 3, data sampler 402, PLL 403 and clock generator 404 of FIGS. 4 and 5 correspond to sampled detector 340, clock synchronizer 342 and clock generator 343, respectively. In this instance, timing recovery loop inputs to PLL 403 in FIGS. 4 and 5 are coupled as inputs to clock synchronizer 342.

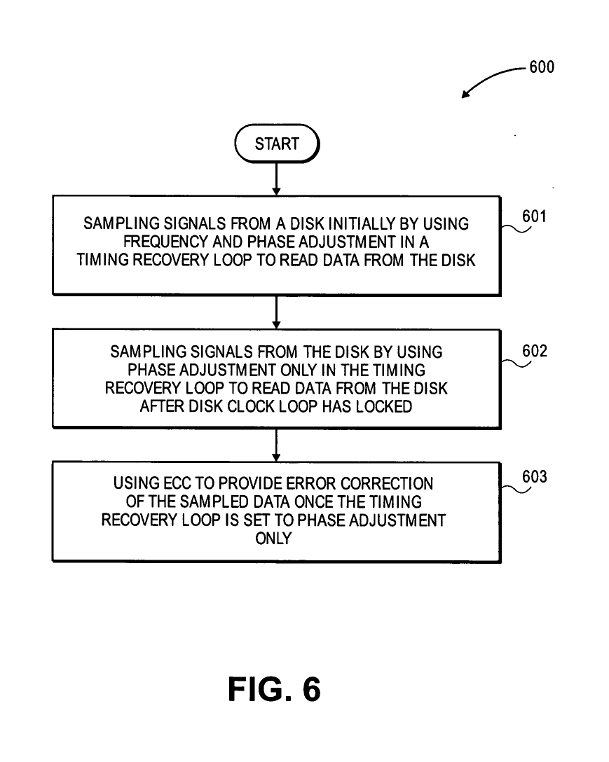

FIG. 6 shows an embodiment of a technique used by the read channel to sample read data and provide error correction to obtain the correct data using a desired level of BER. As shown, read channel of a HDD uses method 600 to sample signals from a disk initially by correcting for frequency and phase offset in a timing recovery loop to synchronize the data sampler to a reference clock (block 601). A typical practice is the use of a PLL as noted in the descriptions above. Both frequency and phase offsets are adjusted for by the PLL during the initialization period where quick reading of data is desired. During this period, DLC system of the HDD is attempting to acquire a lock. The use of both frequency and phase offset to provide timing correction, allows a rapid synchronizing at initialization. However, due to limited tolerances that may be achieved with trying to synchronize a mechanically rotated device, a tighter tolerance technique, such as DLC is desirable for finer adjustments. Otherwise, a higher error rate may result in sampling the read data.

Once DLC acquires a lock, only phase offset adjustment is used in the timing recovery (block 602), since much tighter synchronization tolerances may be achieved with DLC. The DLC allows for a finer adjustment in synchronizing the electronics to the mechanical rotation of the disk. Phase offset with DLC is generally adequate to synchronize the timing with the synchronization marks that are available on preambles of incoming analog signal, which is typically a sine wave signal.

The sampled data is then error corrected using ECC. That is, the read and sampled data is operated by a ECC module using a particular correction scheme, such as Reed Solomon ECC. One advantage of using ECC is that the combination of phase offset for the timing recovery and ECC error correction allows a worse (higher) BER to be tolerated out of the data sampler. The higher BER from the data sampler is tolerated, since the ECC further corrects the error, so that essentially the overall BER out of the ECC module is an acceptable BER for the HDD. Thus, by using an ECC scheme in combination, the disk controller may permit BERs of 10⁻³ (1 bit error per 1000), or even worse, such as 10⁻² from the data sampler. The ECC would then compensate by improving the raw BER from the data sampler to an acceptable BER at the output of the ECC module.

One advantage of using the combination of a DLC/phase offset adjustment with ECC is that HDD migration to larger sector sizes may be achieved with current HDD technology. When the sector size of HDD devices migrate from the current 512 byte sector size to a larger sector size (for example 4096 (4K) byte sector size), current HDD devices operating with some form of recovery loop timing will most likely have worse BER when reading the larger sector size. Such undesirable change in the BER may be readily compensated by redesigning the HDD, such as by adjusting for the SNR. However this scheme most likely requires a redesign for a new HDD. Instead, as described in the above embodiments, if ECC is placed at the output of the data sampler to provide error correction, then current HDD designs need not be changed appreciably to accommodate the larger sector size. Although, the raw BER of the data at the output of the data sampler may be above an unacceptable or undesirable level, the overall BER at the output of the ECC module may be reduced to an acceptable BER level.

Furthermore, for future applications of larger sector size disks, the use of ECC allows 12-bit chunks or 12-bit symbols to be processed effectively, such as by Reed-Solomon ECC, in which the use of 12-bit error correction allows for an effective migration from 512 byte sector size HDDs to 4K byte sector size HDDs.

Thus, phase offset correction for timing recovery with use of ECC in a read channel for a disk drive is described.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled” and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more of its corresponding functions and may further include inferred coupling to one or more other items.

Furthermore, the term “module” is used herein to describe a functional block and may represent hardware, software, firmware, etc., without limitation to its structure. A “module” may be a circuit, integrated circuit chip or chips, assembly or other component configurations. Accordingly, a “processing module” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions and such processing device may have accompanying memory. A “module” may also be software or software operating in conjunction with hardware.

Additionally, the various components noted in the description above, may be implemented separately or integrated onto an integrated circuit (IC) chip, including being integrated as a system on a chip (SoC).

The embodiments of the present invention have been described above with the aid of functional building blocks illustrating the performance of certain functions. The boundaries of these functional building blocks have been arbitrarily defined for convenience of description. Alternate boundaries could be defined as long as the certain functions are appropriately performed. Similarly, flow diagram blocks and methods of practicing the embodiments of the invention may also have been arbitrarily defined herein to illustrate certain significant functionality. To the extent used, the flow diagram block boundaries and methods could have been defined otherwise and still perform the certain significant fumctionality. Such alternate definitions of functional building blocks, flow diagram blocks and methods are thus within the scope and spirit of the claimed embodiments of the invention. One of ordinary skill in the art may also recognize that the functional building blocks, and other illustrative blocks, modules and components herein, may be implemented as illustrated or by discrete components, application specific integrated circuits, processors executing appropriate software and the like or any combination thereof.

We claim:

1. An apparatus comprising:
a data sampler to sample read data from a disk;
a phase locked loop (PLL) coupled to the data sampler to synchronize sampling of the read data to a reference clock, the PLL having a first timing recovery loop that only adjusts a phase offset to synchronize the data sampler; and
an error correction code module to apply error correction code (ECC) to sampled data from the data sampler.

2. The apparatus of claim 1, wherein the PLL further includes a second timing recovery loop that adjusts both frequency and phase offset to synchronize the data sampler.

3. The apparatus of claim 1, wherein the PLL flirther includes a second timing recovery loop that adjusts both frequency and phase offset to synchronize the data sampler during initial operation of the disk prior to a disk clocked clocking acquires a lock to synchronize the data sampler, but the PLL to use the first timing recovery loop with phase offset only to synchronize the data sampler after disk clocked clocking acquires the lock.

4. The apparatus of claim 3 wherein the data sampler samples data in 12-bit chunks.

5. The apparatus of claim 3 wherein the error correction module uses Reed-Solomon ECC.

6. The apparatus of claim 3 wherein the data sampler is coupled to a disk having a sector size of 4K bytes.

7. The apparatus of claim 3, wherein the data sampler, PLL and error correction module are integrated as a system on a chip in an integrated circuit chip.

8. An apparatus comprising:
a storage disk to store data; and
a controller to control reading of data from the storage disk, the controller including:
a data sampler to sample read data from the disk;
a phase locked loop (PLL) coupled to the data sampler to synchronize sampling of the read data to a reference clock, the PLL having a first timing recovery loop that only adjusts a phase offset to synchronize the data sampler; and
an error correction code module to apply error correction code (ECC) to sampled data from the data sampler.

9. The apparatus of claim 8, wherein the PLL further includes a second timing recovery loop that adjusts both frequency and phase offset to synchronize the data sampler during initial operation of the disk prior to a disk clocked clocking acquires a lock to synchronize the data sampler, but the PLL to use the first timing recovery loop with phase offset only to synchronize the data sampler after disk clocked clocking acquires the lock.

10. The apparatus of claim 9, wherein the controller is integrated as a system on a chip in an integrated circuit chip.

11. The apparatus of claim 10, wherein the storage disk is a hard disk.

12. The apparatus of claim 11 wherein the data sampler samples data in 12-bit chunks.

13. The apparatus of claim 11 wherein the error correction module uses Reed-Solomon ECC.

14. The apparatus of claim 11 wherein the data sampler is coupled to a disk having a sector size of 4K bytes.

15. A method comprising:
sampling a signal from a disk by using frequency and phase offset adjustment in a phase locked loop (PLL) timing recovery loop to sample read data from the disk, prior to a disk clocked clocking acquires a lock;
sampling a signal from a disk by using only phase offset adjustment in the PLL timing recovery loop to sample read data from the disk after the disk clocked clocking acquires the lock; and
applying error correction code (ECC) to the sampled read data.

16. The method of claim 15 further including sampling the signal from the disk by sampling data in 12-bit chunks.

17. The method of claim 15 further including sampling the signal from the disk having a sector size of 4K bytes.

18. The method of claim 15, wherein applying the ECC applies the error correction using Reed-Solomon ECC.
